(19) United States
(12) Patent Application Publication
(10) Pub. No.: US 2024/0336043 A1
(43) Pub. Date: Oct. 10, 2024

(54) MULTILAYER FILMS

(71) Applicant: Dow Global Technologies LLC, Midland, MI (US)

(72) Inventors: Bo Liu, Lake Jackson, TX (US); Feng Chen, Shanghai (CN); Zhe Zhou, Lake Jackson, TX (US); Wesley R. Mariott, Manvel, TX (US); Chuan C. He, Missouri City, TX (US)

(21) Appl. No.: 18/293,804

(22) PCT Filed: Oct. 22, 2021
(86) PCT No.: PCT/CN2021/125553

§ 371 Date: Jan. 31, 2024

(51) Int. Cl. B32B 27/08; B32B 27/32

(52) U.S. Cl. CPC B32B 27/08; B32B 27/32; B32B 2250/03; B32B 2250/242; B32B 2307/72

(57) ABSTRACT

A multilayer film comprising at least three layers including (a) at least a first polyolefin layer, wherein the at least first polyolefin layer comprises a first outer layer of the multilayer film: (b) at least a second polyolefin layer, wherein the at least second polyolefin layer comprises a core layer of the multilayer film; and (c) at least a third polyolefin layer, wherein the at least third polyolefin layer comprises a second outer layer (or other layer such as a sealant layer) of the multilayer film: wherein the layers are as described.

### FIELD

The present invention relates to multilayer film structures and more specifically, the present invention relates to multilayer film structures including at least one polyethylene layer such that the multilayer film structures have enhanced mechanical properties. The multilayer film structures of the present invention are useful, for example, in packaging applications.

### BACKGROUND

Multilayer film products are typically used in the packaging industry to pack bulky and heavy materials. The packages made from multilayer films are required to have enough mechanical and abuse resistance properties to withstand the forces and loads that the packages suffer during shipping and storage of such packages. Stiffer and tougher films used for packaging (e.g., in heavy-duty shipping sack applications) would be beneficial for package load increasement and impact/tear resistance improvement.

Heretofore, during the fabrication of multilayer films, a low density polyethylene (LDPE) film has been typically used in the multilayer films to provide good processability/bubble stability to the multilayer film structure during the fabrication of multilayer films. It is believed that the good processability/bubble stability properties of multilayer film structures made from LDPE is due to the presence of long chain branching (LCB) in the LDPE polymer structure. However, LCB is present at high levels (e.g., >2 long chain end/1000 carbons) in the multilayer films of the prior art which contain LDPE; and such high levels of LCB can be detrimental to the properties of the final multilayer film structure. It would be a benefit to the film manufacturing industry to develop a polyethylene resin having improved performances in processability/bubble stability to replace the LDPE resin (e.g., LDPE having LCB) currently used in film applications. Known polymer resins used in manufacturing films include, for example, the polymer resins mentioned in WO2014100889A1, EP2042292A1, EP0735090A1, and WO2021026134.

WO2014100889A1 mentions polymer blends having good processability and good toughness-stiffness balance; and films made from such polymer blends that show good optical properties. The polymer blend described in the above reference includes, for example, (a) 5-99 weight percent (wt %) based on the total weight of the polymer blend, of a first polyethylene copolymer having a density of from 0.916 g/cm³ to 0.936 g/cm³, a melt index (I₂) of from 0.1 g/10 min to 2.0 g/10 min, a melt flow ratio (I₂₁/I₂) of from 32 to 50, and a molecular weight distribution (Mw/Mn) of from 3.6 to 6.5; and (b) 95-5 wt % of a second polyethylene copolymer which is a linear low density polyethylene (LLDPE) having a density of from 0.910 g/cm³ to 0.940 g/cm³, a melt index (I₂) of from 0.2 g/10 min to 5.0 g/10 min, and a melt flow ratio (I₂₁/I₂) of <32.

EP2042292A1 mentions monolayer films or a layer within a multilayer film that can be formed from pellets by simple in-line addition of the pellets to an extruder and then blowing the extruded films to prepare a final film product. The pellets are prepared from a three-component blend polymer composition in the form of pellets comprising: (A) 10 wt % to 90 wt % of a single site produced LLDPE component polymer having a density of <940 kg/m³; (B) 10 wt % to 90 wt % of a multimodal LLDPE polymer having a density of <940 kg/m³; and (C) 1 wt % to 50 wt % of a LDPE polymer. The films disclosed in the above reference have an ideal balance of properties, in particular good optical properties, good impact and toughness and excellent sealing properties. The film is used in packaging applications.

EP0735090A1 mentions a polyethylene resin composition for preparing a film useful for fabricating a heavy-duty shipping sack (HDSS). The polyethylene resin composition includes: (I) from 40 parts by weight to 70 parts by weight of a LLDPE; (II) from 1 part by weight to 55 parts by weight of a linear medium density polyethylene (LMDPE) resin or a linear high density polyethylene (LHDPE) resin; and (III) from 5 parts by weight to 29 parts by weight of a high-pressure LDPE resin. The resulting polyethylene resin composition has: (i) a melt flow rate (190° C.) of from 0.5 g/10 min to 2.0 g/10 min, (ii) a density of from 0.918 g/cm³ to 0.935 g/cm³, and (iii) a melt tension of not less than 5 grams. A blown film prepared from the above polyethylene resin composition can be used for fabricating a heavy-duty packaging bag.

WO2021026134 mentions a multilayer film including at least three layers that provide a balance of stiffness and physical abuse properties, such as dart/bag drop, puncture, tear, and creep resistance. The multilayer films maintain the physical properties that meet customer and industry requirements at reduced film thicknesses or without incorporating a polyamide core layer in the multilayer film structure. According to the above reference, a multilayer film is provided which includes a first layer comprising a polyethylene composition such as a high density polyethylene (HDPE) composition, a second layer comprising a first polyolefin such as a first LLDPE resin, and a third layer comprising a second polyolefin such as a second LLDPE resin. The first LLDPE resin and the second LLDPE resin are the same or different in composition. The first layer may be positioned between the second layer and the third layer. The first layer may include from 10 wt % to 80 wt % of the total weight of the multilayer film.

None of the above reference provide multilayer films having a reduced amount of LCB and having good processability/bubble stability performances while maintaining a balance of the other properties of the multilayer film structure. Therefore, it is desired to provide a multilayer film prepared from a polymer composition having a reduced amount of LCB; and to provide a multilayer film structure with improved performances including both toughness and stiffness.

### SUMMARY

One embodiment of the present invention is directed to a multilayer film including at least the following three layers: (a) at least a first polyolefin layer comprising an outer film layer of the multilayer film; (b) at least a second polyolefin layer comprising a core film layer of the multilayer film; and (c) at least a third polyolefin layer comprising an outer film layer of the multilayer film. The at least third polyolefin layer of the multilayer film may be the same or different than the at least first polyolefin layer of the multilayer film. The at least second polyolefin layer of the multilayer film comprising a core film layer may be disposed in-between the at least first polyolefin layer of the multilayer film and the at least third polyolefin layer of the multilayer film. The at least first polyolefin layer of the multilayer film, the at least second polyolefin layer of the multilayer film, and the at least third polyolefin layer of the multilayer film are contacted together to form the multilayer film structure of the present invention.

Another embodiment of the present invention includes a process for producing the above multilayer film.

Still another embodiment of the present invention includes a packaging article such as a heavy-duty shipping sack for use in packaging applications.

Yet another embodiment of the present invention includes a multilayer film structure having three or more film layers in which at least one of the three or more film layers of the multilayer film structure comprises the above-described three or more film layers.

One objective of the present invention is to produce a multilayer film structure having an increase performance in properties such as toughness and stiffness; wherein each layer of the multilayer film is made from a polyolefin polymer resin (e.g., an ethylene-based or polyethylene-based polymer resin); and wherein all of the polyolefin polymer resins of the multilayer film are collectively referred to as a polymer resin blend composition. The objective can be achieved by using, for example, a polyethylene-based polymer resin composition having a low amount of long chain branching (LCB) instead of other known resin compositions having a high amount (e.g., >2 branch/1000 carbons) of long chain end (LCE) to prepare the multilayer film. For example, a polyethylene-based polymer resin blend composition useful in the present invention comprises a polymer resin blend composition wherein at least one of the polyethylene-based polymer resins present in the polymer resin blend composition is at least one metallocene catalyzed LLDPE resin having a LCB value of from 0.001 branch/1000 carbons to <0.1 branch/1000 carbons; and/or at least one Zeigler-Natta (ZN) catalyzed LLDPE resin. Polyethylene-based polymer resin blend compositions of the present invention, such as the above LLDPE resins having a low level of LCB (e.g., a LCB of from 0.001 branch/1000 carbons to <0.1 branch/1000 carbons in one embodiment; and a LCB of from 0.001 branch/1000 carbons to <0.050 branch/1000 carbons in another embodiment), advantageously and surprisingly provide multilayer films with improved performances including toughness and stiffness.

### BRIEF DESCRIPTION OF THE DRAWINGS

FIG. 1 is a schematic cross-sectional view of a multilayer film structure comprising three film layers.

FIG. 2 is a schematic cross-sectional view of a multilayer film structure comprising seven film layers.

### DETAILED DESCRIPTION

Specific embodiments of the present application will now be described. These embodiments are provided so that this disclosure will be thorough and complete and will fully convey the scope of the claimed subject matter to those skilled in the art.

Unless stated to the contrary, implicit from the context, or customary in the art, all parts and percent values are based on weight, all temperatures are in ° C., and all test methods are current as of the filing date of this disclosure.

Temperatures used herein are in degrees Celsius (° C.).

“Room temperature (RT)” and “ambient temperature” herein means a temperature between 20° C. and 26° C., unless specified otherwise.

The term “composition,” as used herein, refers to a mixture of materials which comprises the composition, as well as reaction products and decomposition products formed from the materials of the composition.

The term “polymer” refers to a polymeric compound prepared by polymerizing monomers, whether of a same or a different type. The generic term “polymer” thus embraces (1) the term “homopolymer,” which usually refers to a polymer prepared from only one type of monomer; and (2) the term “copolymer,” which refers to a polymer prepared from two or more different monomers. The term “interpolymer,” as used herein, refers to a polymer prepared by the polymerization of at least two different types of monomers. The generic term “interpolymer” thus includes a copolymer or polymer prepared from more than two different types of monomers, such as terpolymers.

“Polyethylene” or “ethylene-based polymer” shall mean polymers comprising >50% by mole of units which have been derived from ethylene monomer. This includes ethylene-based homopolymers or copolymers (meaning units derived from two or more comonomers). Common forms of ethylene-based polymers known in the art include, but are not limited to, low density polyethylene (LDPE); linear low density polyethylene (LLDPE); ultra low density polyethylene (ULDPE); very low density polyethylene (VLDPE); single-site catalyzed LLDPE, including both linear and substantially linear low density resins (e.g., mLLDPE); medium density polyethylene (MDPE); and high density polyethylene (HDPE). The “polyethylene” or “ethylene-based polymer” useful in the present invention has at least 50 wt % ethylene-derived units in one embodiment, at least 70 wt % ethylene-derived units in another embodiment, at least 80 wt % ethylene-derived units in still another embodiment, at least 90 wt % ethylene-derived units in still another embodiment, at least 95 wt % ethylene-derived units in yet another embodiment, and 100 wt % ethylene-derived units in even still another embodiment.

The term “LDPE” may also be referred to as “high pressure ethylene polymer” or “highly branched polyethylene” and is defined to mean that the polymer is partly or entirely homopolymerized or copolymerized in autoclave or tubular reactors at pressures >14,500 psi (100 MPa) with the use of free-radical initiators, such as peroxides (see, for example, U.S. Pat. No. 4,599,392, which is hereby incorporated by reference). LDPE resins typically have a density in the range of 0.916 g/cm³ to 0.940 g/cm³.

The term “LLDPE,” includes resins made using Ziegler-Natta (ZN) catalysts as well as resins made using metallocene catalysts, including, but not limited to, bis-metallocene catalysts (sometimes referred to as “m-LLDPE”), phosphinimine, and constrained geometry catalysts, and resins made using post-metallocene, molecular catalysts, including, but not limited to, bis (biphenylphenoxy) catalysts (also referred to as polyvalent aryloxyether catalysts). LLDPEs includes linear, substantially linear, or heterogeneous ethylene-based copolymers or homopolymers. LLDPEs contain less LCB than LDPEs and include the substantially linear ethylene polymers, which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. Nos. 3,914,342 and 5,854,045). The LLDPE resins can be made via gas-phase, solution-phase, or slurry polymerization or any combination thereof, using any type of reactor or reactor configuration known in the art.

The term “MDPE” refers to polyethylenes having densities from 0.924 g/cm³ to 0.942 g/cm³. “MDPE” is typically made using chromium or Ziegler-Natta catalysts or using metallocene catalysts including, but not limited to, substituted mono-or bis-cyclopentadienyl catalysts (typically referred to as metallocene), constrained geometry catalysts, phosphinimine catalysts and polyvalent aryloxyether catalysts (typically referred to as bisphenyl phenoxy).

The term “HDPE” refers to polyethylenes having densities >about 0.935 g/cm³ and up to about 0.980 g/cm³, which are generally prepared with ZN catalysts, chrome catalysts or metallocene catalysts including, but not limited to, substituted mono-or bis-cyclopentadienyl catalysts (typically referred to as metallocene), constrained geometry catalysts, phosphinimine catalysts, polyvalent aryloxyether catalysts (typically referred to as bisphenyl phenoxy), and mixtures thereof.

“Blend”, “blend resin,” “blend polymer”, “polymer blend,” and like terms, with reference to a polymer composition, mean a composition of two or more polymers. Such a blend polymer may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

“Multilayer structure” or “multilayer film” means any structure having more than one layer. For example, the multilayer structure (for example, a film) may have two, three, four, five, or more layers. A multilayer structure may be described as having the layers designated with letters. For example, a three-layer structure designated as A/B/C may have a core layer, B, and two external layers, A and C. Likewise, a structure having two core layers, B and C, and two external layers, A and D, would be designated A/B/C/D.

The term “molecular weight distribution” means the same thing as polydispersity index (PDI). The molecular weight distribution (Mw/Mn) is the ratio of weight-average molecular weight (Mw) to number-average molecular weight (Mn), i.e., Mw/Mn. Mw, Mn, and Mz can be measured using gel permeation chromatography (GPC), also known as size exclusion chromatography (SEC). Measurement of molecular weight by SEC is well known in the art.

The term “toughness”, with reference to a film structure, herein is correlated to the dart drop impact value determined according to procedure described in ASTM D1709-16.

The term “stiffness”, with reference to a film structure, herein is correlated to the secant modulus value of the film determined according to the procedure described in ASTM D882-18.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like.).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; “≥” means “greater than or equal to”; “@” means “at”; “MT”=metric ton(s); g=gram(s); mg=milligram(s); Kg=kilogram(s); g/L=gram(s) per liter; μL=microliter(s); “g/cm³” or “g/cc”=gram(s) per cubic centimeter; g/10 min=gram(s) per 10 minutes; mg/mL=milligrams per milliliter; “kg/m³=kilogram(s) per cubic meter; ppm=parts per million by weight; pbw=parts by weight; rpm=revolutions per minute; m=meter(s); mm=millimeter(s); cm=centimeter(s); μm=micron(s) or micrometer(s); min=minute(s); s=second(s); ms=millisecond(s); hr=hour(s); Pa=pascals; MPa=megapascals; Pa·s=Pascal second(s); mPa·s=millipascal second(s); g/mol=gram(s) per mole(s); g/eq=gram(s) per equivalent(s); Mₙ=number average molecular weight; M_{w}=weight average molecular weight; pts=part(s) by weight; 1/s or sec⁻¹=reciprocal second(s) [s⁻¹]; ° C.=degree(s) Celsius;° C./min=degree(s) Celsius per minute; psi=pounds per square inch; kPa=kilopascal(s); %=percent; vol %=volume percent; mol %=mole percent; and wt %=weight percent.

Unless stated otherwise, all percentages, parts, ratios, and the like amounts, are defined by weight. For example, all percentages stated herein are weight percentages (wt %), unless otherwise indicated.

Specific embodiments of the present invention are described herein below. These embodiments are provided so that this disclosure is thorough and complete; and fully conveys the scope of the subject matter of the present invention to those skilled in the art.

In one broad embodiment, the multilayer film of the present invention comprises at least three layers including: at least a first polyolefin layer, at least a second polyolefin layer, and at least a third polyolefin layer, and two or more of the first, second and third polyolefin layers can be the same or different.

In some embodiments, each of the polyolefin layers making up the multilayer film of the present invention is prepared from a polyolefin resin composition. In a preferred embodiment, the polyolefin resin composition of each of the polyolefin layers making up the multilayer film of the present invention includes at least one or more ethylene-based polymer resins. In another preferred embodiment, the ethylene-based polymer resin composition of each of the polyolefin layers making up the multilayer film of the present invention includes at least one or more LLDPE polymer resins.

In still another preferred embodiment, each of the three polyolefin layers of the multilayer film is formed from a blend of at least two or more polyolefin polymer resins. And, the at least two or more polyolefin polymer resins in each of the polyolefin layers of the multilayer film includes at least one polymer resin selected from the group consisting of: (i) a Zeigler-Natta (ZN) catalyzed LLDPE resin (abbreviated herein “ZN-LLDPE resin”); (ii) a metallocene catalyzed LLDPE resin (abbreviated herein “mLLDPE resin”); (iii) another metallocene catalyzed LLDPE resin with LCB (abbreviated herein “mLLDPE-LCB resin”) which is a metallocene catalyzed LLDPE resin having a LCB value of from 0.001/1000 carbons to <0.1/1000 carbons; (iv) optionally, a HDPE resin, and (v) mixtures thereof.

Exemplary of the above resins (i)-(iv) useful in the present invention may include, but not limited to, the following resins:

(1) a ZN catalyzed LLDPE resin, such as ZN-LLDPE DFDA-7047 (available from Univation), which is a poly (ethylene-co-1-butene) copolymer resin having a density of 0.918 g/cm³ and a melt index of 1 g/10 min; and made by the “UNIPOL™M PE Process” using a Ziegler-Natta catalyst, such as UCATTM J catalyst (available from Univation);

(2) another ZN catalyzed LLDPE resin, such as ZN-LLDPE DFDA-7042 (available from Univation), which is another poly (ethylene-co-1-butene) copolymer resin having a density of 0.918 g/cm3 and a melt index of 2 g/10 min; and made by the UNIPOL™M PE Process using a Ziegler-Natta catalyst, such as UCATTM J catalyst (available from Univation);

(3) a mLLDPE resin, such as MCN-LLDPE HPR 1018HA (available from Univation), which is a poly (ethylene-co-1-hexene) copolymer resin having a density of 0.918 g/cm³ and a melt index of 1 g/10 min; and made by the UNIPOL™M PE Process using a metallocene catalyst, such as XCAT™ HP-100 catalyst (available from Univation);

(4) a HDPE resin, such as HDPE DGDZ-6095 (available from Univation), which is another poly (ethylene-co-1-hexene) copolymer resin having a density of 0.948 g/cm³ and a flow index of 10 g/10 min; and made by the UNIPOL™ PE Process using a chromium catalyst, such as ACCLAIM™ K-100 catalyst (available from Univation);

(5) another mLLDPE resin, such as EZ-LLDPE EZP 2703 (available from Univation), which is another poly (ethylene-co-1-hexene) copolymer resin having a density of 0.928 g/cm3 and a melt index of 0.3 g/10 min; and made by the UNIPOL™ PE Process using a metallocene catalyst, such as XCAT™ EZ-100 catalyst (available from Univation); and the mLLDPE resin, such as EZ-LLDPE EZP 2703, has a LCB value of from 0.001/1000 carbons to <0.1/1000 carbons;

(6) another mLLDPE resin, such as EZ-LLDPE EZP 2010 (available from Univation), another poly (ethylene-co-1-hexene) copolymer resin having a density of 0.922 g/cm³ melt index of 1 g/10 min; and made by the UNIPOL™M PE Process using a metallocene catalyst, such as XCAT™ EZ-100 catalyst (available from Univation.); and the mLLDPE resin, such as EZ-LLDPE EZP 2010, has a LCB value of from 0.001/1000 carbons to <0.1/1000 carbons;

(7) a LDPE resin, such as LDPE 150E (available from The Dow Chemical Company), having a density of 0.921 g/cm3 and a melt index of 0.3 g/10 min;

(8) a LDPE resin, such as LDPE 450E (available from The Dow Chemical Company), having a density of 0.923 g/cm³ and a melt index of 2 g/10 min; and (9) mixtures of any two or more of the above resins (1)-(8).

In some embodiments, when the mLLDPE resin (e.g., EZ-LLDPE EZP 2010 catalyzed with XCAT™ EZ-100) is present in one of the layers of the multilayer film, the concentration of such mLLDPE resin is from 5 wt % to 28 wt % in one embodiment; from 10 wt % to 20 wt % in another embodiment; and from 8 wt % to 18 wt % in still another embodiment. In other embodiments, when the mLLDPE resin is present in two or more of the layers of the multilayer film, the total concentration of such mLLDPE resin is from 5 wt % to 28 wt % in one embodiment; from 10 wt % to 20 wt % in another embodiment; and from 8 wt % to 18 wt % in still another embodiment.

One of the advantages of the present invention is that by controlling the concentration of the mLLDPE resin (e.g., EZ-LLDPE EZP 2010 catalyzed with e.g. XCAT™ EZ-100) used to form the one or more layers of the multilayer film, the amount of LCB occurring in the resin(s) is also controlled or maintained at a beneficial range (i.e., the amount of LCB does not exceed a predetermined amount) that does not deleteriously affect the performance properties of toughness and stiffness of the multilayer film. By adding the proper predetermined amount of the mLLDPE resin to the polyolefin resin composition used to form the one or more layers of the multilayer film, the amount of LCB occurring in the resin(s) can, in turn, be controlled to the proper amount of LCB as measured by known techniques. The amount of the LCB occurring in any of the LLDPE resins can be measured using nuclear magnetic resonance (NMR) spectroscopy as described in, for example, Z. Zhou, S. Pesek, J. Klosin, M. Rosen, S. Mukhopadhyay, R. Cong, D. Baugh, B. Winniford, H. Brown, K. Xu, “Long chain branching detection and quantification in LDPE with special solvents, polarization transfer techniques, and inverse gated 13C NMR spectroscopy”, Macromolecules, 2018, 51, 8443; Z. Zhou, C. Anklin, R. Cong, X. Qiu, R. Kuemmerle, “Long-chain branch detection and quantification in ethylene-hexene LLDPE with 13C NMR”, Macromolecule, 2021, 54, 757; and Z. Zhou, C. Anklin, R. Kuemmerle, R. Cong, X. Qiu, J. DeCesare, M. Kapur, R. Patel, “Very sensitive 13C NMR method for the detection and quantification of long-chain branches in ethylene-hexene LLDPE”, Macromolecule, 2021, 54, 5985.

For example, in some embodiments, the LCB level of the mLLDPE resin present in the multilayer film is controlled in the range of <0.1/1000 carbons in one embodiment, <0.05/1000 carbons in another embodiment, and <0.03/1,000 carbons in still another embodiment. In other embodiments, the LCB level of the mLLDPE resin is controlled in the range of from 0.001/1000 carbons to <0.1/1000 carbons in one embodiment; and from 0.001/1000 carbons to 0.05/1000 carbons in another embodiment, to provide an improvement in performance in dart and to maintain a balance of the other properties (e.g., the processability of the resin).

In some embodiments, one or more other ethylene-based polymer resins that can be optionally used in combination with any one or more of the above-described LLDPE resins (e.g., resins (i), (ii) and (iii)) to form the polymer resin blend compositions of the present invention. For example, besides the mLLDPE resin present in the polymer resin blend composition of at least one layer of the multilayer film, the polymer resin blend composition can include another ethylene-based polymer resin. For example, in one embodiment, the polymer resin blend composition can include a blend of: a metallocene (e.g., XCAT™ EZ-100) catalyzed LLDPE resin such as EZP 2703 resin (available from Univation), EZP 2010 resin (available from Univation), and mixtures thereof; and at least one ethylene-based polymer resin selected from the group consisting of, for example, a LDPE resin, another LLDPE resin, an optional HDPE, and combinations thereof.

In another embodiment, the polymer resin blend composition can include a blend of: a metallocene (e.g., XCAT™ EZ-100) catalyzed LLDPE resin; and the other polymer resin present in the polymer resin blend composition can include, for example, a ZN-LLDPE resin such as DFDA7047 resin (available from Univation).

In some embodiments, the other polymer resin present in the polymer resin blend composition can include, for example, a HDPE resin (e.g., resin (iv) having a density of from 0.945 g/cm³ to 0.955 g/cm³ in one general embodiment; and having a flow index I_{21.6} of from 7 g/10 min to 20.0 g/10 min in one general embodiment. An example of a HDPE resin useful in the present invention is HDPE 6095 resin (available from Univation).

Generally, each of the above-described mLLDPE resins useful in the present invention has a density in the range of from 0.905 g/cm³ to 0.940 g/cm³ in one embodiment; from 0.910 g/cm³ to 0.936 g/cm³ in another embodiment, from 0.915 g/cm³ to 0.930 g/cm³; in still another embodiment; from 0.915 g/cm³ to 0.926 g/cm³ in yet another embodiment, and from 0.915 g/cm³ to 0.922 g/cm³ in even still another embodiment. The density of such polymer resins can be determined in accordance with the procedure described in ASTM D 792-13.

In general, each of the above-described LLDPE polymer resins useful in the present invention has a melt index (MI₂) in the range of from 0.1 g/10 min to 5 g/10 min in one embodiment; from 0.1 g/10 min to 3 g/10 min in another embodiment; from 0.15 g/10 min to 2.7 g/10 min in another embodiment; from 0.2 g/10 min to 2.7 g/10 min in another embodiment; from 0.5 g/10 min to 2.7 g/10 min in another embodiment; from 0.8 g/10 min to 2.5 g/10 min in still another embodiment, from 0.8 g/10 min to 1.5 g/10 min in yet another embodiment, and from 0.9 g/10 min to 1.2 g/10 min in still another embodiment. The MI₂ of such polymer resins can be determined using the procedure described in ASTM D 1238-03 (at 190° C. and using a 2.16 kg weight).

In other embodiments, the mLLDPE resin (e.g., the metallocene, such as XCAT™ EZ-100, catalyzed LLDPE resin) has a melt index (MI) of from 0.1 g/10 min to 5 g/10 min in one embodiment, from 0.15 g/10 min to 2.5 g/10 min in another embodiment, and from 0.2 g/10 min to 1.5 g/10 min in still another embodiment.

In other embodiments, a LLDPE-LCB resin can be used in the polymer resin blend composition. The LLDPE-LCB resin can be, for example, resin (iii) selected from the resins (i)-(v) described above. Generally, the LLDPE-LCB resin has a density of from 0.912 to 0.935, a MI₂ of from 0.2 to 1.5; and uses a hexene comonomer metallocene catalyst. Also, in some embodiments, the resin (iii) has a Mw/Mn ratio of from 2.9 to approximately (˜) 4.3. in one general embodiment. The weight molecular weight (Mw) and the average number molecular weight (Mn) to arrive at the Mw/Mn ratio is determined using gel permeation chromatography. In other embodiments, the LCB value of the resin (iii) is in the range of from 0.001/1000 carbons to 0.1/1000 carbons in one general embodiment. In other embodiments, the HD fraction >95° C., as measured by iCCD method, of the resin (iii) is <5% in one embodiment, <4% in another embodiment, and <3% in still another embodiment.

In some embodiments of the present invention, the LLDPE resins (e.g., resins (i), (ii) and (iii)), used to form of the first layer, second layer and third layer, respectively, of the multilayer film interact with each other; and this interaction can be observed by the value of the melt index of the resins. For example, the MI₂ of resin (iii) is generally less than the MI2 of resin (i) and/or the MI₂ of resin (ii). In general, the MI₂ of resin (iii) comports with the following general Equation (I):

$$k * {MI}_{2} of resin ( i ) or \\ {MI}_{2} of resin ( ii ) is > {MI}_{2} of resin ( iii ) \qquad Equation ( I )$$

wherein in Equation (I) above, the factor k can be in the range of from 0.4 to ˜0.8 in one embodiment, from 0.4 to ˜0.6 in another embodiment, and from 0.4 to ˜0.5 in still another embodiment.

The above relationship of the LLDPE resins (e.g., resins (i), (ii) and (iii)), is important because a lower melt index will provide a higher melt strength; and a higher melt strength will provide better bubble stability during the film making process.

As illustrations of some embodiments, and not to be limited thereby, each of the three layers (a), (b) and (c) of the multilayer film structure of the present invention; and the ethylene-based polymer resin blend compositions (e.g., selected from one or more of the above-described resins (i) to (v)) used to form the three layers are described in more detail herein below.

The multilayer film structures according to the present invention may include two or more layers. In a preferred embodiment, the multilayer films of the present invention have three or more layers. For example, the multilayer film structures of the present invention may include at least three layers in one embodiment; five layers in another embodiment; 7 layers in still another embodiment; and up to as many as 13 layers or more layers in yet other embodiments. The number of layers in the multilayer film may depend on a number of factors including, for example, the composition of each layer in the multilayer film, the desired properties of the multilayer film, the desired end-use application of the multilayer film, the manufacturing process of the multilayer film, and other factors.

In one preferred embodiment, the multilayer film of the present invention is a three-layer structure designated as A/B/C, where the first layer may be designated as A, the second layer may be designated as B, and the third layer may be designated as C.

In some embodiments, the second layer of the multilayer film may be referred to as a “core layer”; and the core layer may be a monolayer or two or more monolayers (i.e., a multilayer core layer). In some embodiments, one or both of the first layer of the multilayer film and the third layer of the multilayer film may be referred to as “skin layers”, “outer layers”, or “inner layers”; and the first layer of the multilayer film and the third layer of the multilayer film may be a monolayer or two or more monolayers (i.e., a multilayer outer layer or an inner layer). In further embodiments, the first layer of the multilayer film and the third layer of the multilayer film may be printable layers and/or sealable layers. For example, in some embodiments the first layer of the multilayer film and the third layer of the multilayer film may both be printable outer layers; or both the first layer of the multilayer film and third layer of the multilayer film may be sealable inner layers. In other embodiments, the first layer of the multilayer film may be a printable outer layer and the third layer of the multilayer film may be a sealable inner layer; or the first layer of the multilayer film may be a sealable inner layer and the third layer of the multilayer film may be a printable outer layer.

In some embodiments, the second layer (core layer) of the multilayer film may be positioned between the first layer of the multilayer film and the third layer of the multilayer film. In further embodiments, the first layer of the multilayer film and the third layer of the multilayer film may be the outermost layers of the multilayer film. As used herein, an “outermost layer” of a multilayer film may be understood to mean there may not be another layer deposited over the outermost layer of the multilayer film, such that the outer surface of the outermost layer of the multilayer film is in direct contact with the surrounding air and the inner surface of the outermost layer of the multilayer film is in direct contact with the core layer of the multilayer film. For example, the first layer of the multilayer film and the second layer of the multilayer film and/or the third layer of the multilayer film and second layer of the multilayer film may be in direct contact with one another. As used herein, “direct contact” means that there may not be any other layers positioned between two layers that are in direct contact with one another.

In other embodiments, the multilayer film of the present invention may optionally include one or more additional layers, for example, one or more tie layers, which may be disposed between the first layer (an outer layer) of the multilayer film and the second layer (the core layer) of the multilayer film; and/or between the second layer (the core layer) of the multilayer film and the third layer (another outer layer) of the multilayer film. The type of additional optional layers that may be used in the present invention are described herein below.

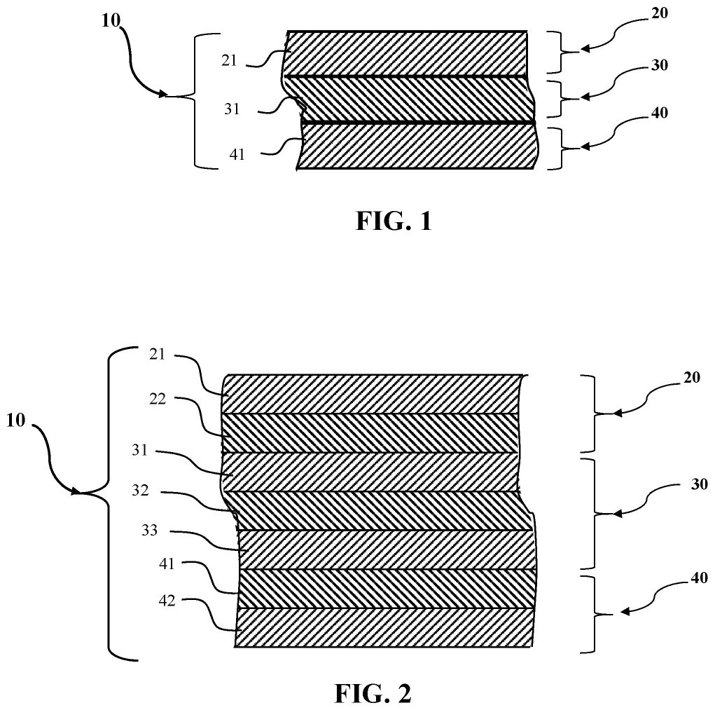

With reference to FIG. 1, there is shown one embodiment of the multilayer film of the present invention, generally indicated by reference numeral 10. In one embodiment, the multilayer film 10 includes a multilayer film having at least 3 layers in the film structure 10. For example, in a preferred embodiment, the 3-layer multilayer film 10 includes: (a) at least a first layer comprising at least a first outer polyolefin layer (a skin layer or top layer) of the multilayer film, generally indicated by reference numeral 20; (b) at least a second layer comprising at least a core polyolefin layer (a middle layer) of the multilayer film, generally indicated by reference numeral 30; and (c) at least a third layer comprising at least a second outer polyolefin layer (a skin layer or bottom layer) of the multilayer film, generally indicated by reference numeral 40. The first outer layer 20 and the second outer layer 40 can be the same or different from each other. As shown in FIG. 1, the core polyolefin layer 30 is disposed in between the first outer film layer 20 and the second outer film layer 40, i.e., the two outer layers 20 and 40 sandwich the core layer 30; and the first layer, the second layer, and the third layer (film layers 20, 30 and 40, respectively) are contacted and bonded together to form the multilayer film structure 10.

The outer layers which include the first layer 20 and the third layer 40 may also be referred to as “skin layers” or “external layers”. The outer layer 20 can also be referred to as a “top layer” and the outer layer 40 can also be referred to as a “bottom layer”. The core layer 30 which includes the second layer may also be referred to as a “middle layer”. In some embodiments, each of the layers 20, 30 and 40 of the multilayer film of the present invention may be a monolayer; and in another embodiment, each of the layers 20, 30 and 40 of the multilayer film of the present invention may include a plurality of the same monolayers or a combination of different monolayers to form the multilayer film. The term “core” or the phrase “core layer”, refers to any internal film layer in a multilayer film; and the phrase “skin layer” refers to an outermost layer of a multilayer film.

The multilayer film shown in FIG. 1, which comprises the at least three-layer film structure (film layers 20, 30 and 40), can be designated as film layers A/B/C, wherein the outer layers 20 and 40 may be designated as A and C, respectively; and the core layer 30 may be designated as B. In other embodiments of the above designated 3-layer film structure, the outermost layers (layers A and C) of the multilayer film may be in direct contact with the core layer B. In the embodiment of the present invention shown in FIG. 1, each of the layers 20, 30, 40 making up the multilayer film is a monolayer indicated by reference numerals 21, 31 and 41, respectively.

With reference to FIG. 2, there is shown another embodiment of the multilayer film structure of the present invention having at least seven layers because each of the layers 20, 30, 40 comprise a multiple number (e.g., 2 or more) of layers (or sublayers). Thus, the seven-layer multilayer film structure shown in FIG. 2, comprises, for example, two film layers or sublayers for forming film 20 of the multilayer film, three film layers or sublayers for forming film 30 of the multilayer film, and two film layers or sublayers for forming film 40 of the multilayer film. In the embodiment shown in FIG. 2, layer 20 includes an outer layer 21 and an intermediate layer 22, wherein the intermediate layer 22 is disposed in between the outer layer 21 and the core layer 30. The layer 40, shown in FIG. 2, includes an outer layer 41 and an intermediate layer 42; wherein the intermediate layer 42 is disposed in between the outer layer 41 and the core layer 30. And, in FIG. 2, there is shown the core layer 30 comprising a combination of at least three layers such as a first core layer 31, a second core layer 32, and a third core layer 33; the core layers being disposed in between the outer layers 20 and 40, wherein the first core 31 is in contact with the intermediate layer 22 and the core layer 33 is in contact with the intermediate layer 42.

The multilayer film shown in FIG. 2, which comprises the at least a seven-layer film structure can be designated as film layers A/B/C/D/E/F/G, wherein the outer layer 20 may be designated as film layers A and B; the outer layer 40 may be designated as film layers F and G; and the core layer 30 may be designated as film layers C, D and E. In other embodiments of the above designated 7-layer film structure, the outermost layers, layers A and G, of the multilayer film may include an inner layer B and F, respectively where the inner layers B and F are in direct contact with the core layers C and E, respectively.

In a broad embodiment, each of the at least three layers of the multilayer film of the present invention is formed from various resins; and, in one embodiment, each of the at least three layers includes a blend of two or more polyolefin polymer resins. In some embodiments, at least one of the layers of the multilayer film includes a polymer resin comprising a mLLDPE resin; that is, a predetermined concentration of the mLLDPE can be present in any one or more of the layers of the multilayer film structure. For example, the outer polyolefin layer (the first layer of the multilayer film), the core polyolefin layer (the second layer of the multilayer film), and/or the sealant polyolefin layer (the third layer of the multilayer film) can include a mLLDPE resin.

In one general embodiment, the first film layer of the multilayer film useful in the present invention can be a monolayer or a combination of two or more monolayers (i.e., a multiple number of layers forming the first film layer of the multilayer film). In addition, the first film layer of the multilayer film useful in the present invention can be formed from a single polyolefin resin or a blend of two or more polyolefin resins. In one embodiment, the first film layer of the multilayer film is formed, for example, from one or more ethylene-based polymer components. In other embodiments, the first layer of the multilayer film comprises a polymer resin blend composition that can be used to fabricate a printable outer skin layer as the first layer.

In another embodiment, the first film layer of the multilayer film is a combination or blend of two or more ethylene-based polymer components selected from two or more of the above-described resins (i) to (v)). For example, in another embodiment, the first film layer of the multilayer film comprises a polymer resin blend composition of a blend of LLDPEs such as a blend of resin (i), a ZN-LLDPE; resin (ii), an MCN-LLDPE; resin (iii), an EZ-LLDPE, and optionally resin (iv), a HDPE.

In one preferred embodiment, the LLDPE polymer resins used for forming the polymer resin blend composition for the first film layer of the multilayer film includes resin (i), resin (ii) and resin (iii). Each of the LLDPE polymer resins (e.g., resin (i), resin (ii) and resin (iii)) in the blend of resins used for forming the first polyolefin film layer 20 of the multilayer film 10 has a density ranging from 0.912 g/cm³ to 0.925 g/cm³ in one embodiment; from 0.915 g/cm³ to 0.923 g/cm³ in another embodiment, and from 0.916 g/cm³ to 0.922 g/cm³ in still another embodiment. The density of each of the LLDPE polymers is determined in accordance with the procedure described in ASTM D 792-13.

In general, each of the LLDPE polymers (e.g., resin (i), resin (ii) and resin (iii)) in the blend of resins used for forming the first polyolefin film layer 20 of the multilayer film 10 has a melt index (I₂) ranging from 0.5 g/10 min to 2.5 g/10 min in one embodiment; from 0.6 g/10 min to 2.1 g/10 min in another embodiment, from 0.8 g/10 min to 1.5 g/10 min in still another embodiment, and from 0.9 g/10 min to 1.2 g/10 min in yet another embodiment. The melt index (I2) of each of the LLDPE polymers is determined using the procedure described in ASTM D 1238-03 (at 190° C. and using a 2.16 kg weight).

In general, each of the LLDPE polymers (e.g., resin (i), resin (ii) and resin (iii)) in the blend of resins used for forming the first polyolefin film layer 20 of the multilayer film 10 has a molecular weight distribution (Mw/Mn) ranging from 2 to 6 in one embodiment; from 3 to 5 in another embodiment; and from 3.5 to 4.5 in still another embodiment. The molecular weight (Mw) and molecular weight (Mn) of the LLDPE polymers is determined using gel permeation chromatography.

As an illustration of the present invention and not to be limited thereby, in some embodiments, the polymer resin composition for fabricating the first layer of the multilayer film, comprises a polymer resin blend composition including resin (i), resin (ii), and resin (iii) as follows:

(1) resin (i) comprises from 10 wt % to 50 wt % of resin (i) in one embodiment, from 10 wt % to 40 wt % in another embodiment, and from 10 wt % to 30 wt % in still another embodiment; and wherein resin (i) comprises a Ziegler-Natta catalyzed LLDPE resin (e.g., Univation DFDA 7047 resin);

(2) resin (ii) comprises from 40 wt % to 70 wt % of resin (ii) in one embodiment, from 50 wt % to 70 wt % in another embodiment, and from 55 wt % to 65 wt % in still another embodiment, and wherein resin (ii) comprises a metallocene catalyzed LLDPE resin (e.g., Univation HPR 1018HA resin); and (3) resin (iii) comprises from 5 wt % to 28 wt % of resin (iii) in one embodiment, from 10 wt % to 25 wt % in another embodiment, and from 10 wt % to 20 wt % in still another embodiment; and wherein resin (iii) comprises a metallocene catalyzed LLDPE resin with LCB (e.g., Univation EZP 2703 resin); and wherein the LCB value of resin (iii) is, for example, <0.030 branch/1000 carbons.

In one general embodiment, the second film layer of the multilayer film useful in the present invention can be a monolayer or a combination of two or more monolayers (i.e., a multiple number of layers forming the second film layer of the multilayer film). In addition, the second film layer of the multilayer film useful in the present invention can be formed from a single polyolefin resin or a blend of two or more polyolefin resins. In one embodiment, the second film layer of the multilayer film is formed, for example, from one or more ethylene-based polymer components. In another embodiment, the second layer of the multilayer film is the core layer of the multilayer film.

In another embodiment, the second film layer of the multilayer film is a combination or blend of two or more ethylene-based polymer components selected from two or more of the above-described resins (i) to (v)). For example, in another embodiment, the second film layer of the multilayer film comprises a polymer resin blend composition of a blend of LLDPEs such as a blend of resin (i), a ZN-LLDPE; resin (ii), an MCN-LLDPE; resin (iii), an EZ-LLDPE, and optionally resin (iv), a HDPE.

In one preferred embodiment, the polymer resins used for forming the polymer resin blend composition for the second film layer of the multilayer film includes resin (ii), resin (iii) and resin (iv). The ethylene-based polymer resin blend composition for forming the second polyolefin film layer 30 of the multilayer film 10 includes a LLDPE resin such as resins (ii) and (iii) described above. The ethylene-based polymer resin blend composition for forming the second polyolefin film layer 30 of the multilayer film 10 also includes a HDPE resin (e.g., resin (iv) having a density of from 0.945 g/cm₃ to 0.955 g/cm₃ in one general embodiment; and having a flow index I_{21.6} of from 7 g/10 min to 20.0 g/10 min in one general embodiment. An example of a HDPE resin useful in the present invention is HDPE 6095 resin (available from Univation).

In general, the blend of polymer resins used for forming the second polyolefin film layer 30 of the multilayer film 10 has a molecular weight distribution (Mw/Mn) ranging from 2 to 6 in one embodiment; from 3 to 5 in another embodiment; and from 3.5 to 4.5 in still another embodiment. The weight-average molecular weight (Mw) and number-average molecular weight (Mn) of the LLDPE polymers is determined using gel permeation chromatography.

As an illustration of the present invention and not to be limited thereby, in some embodiments, the polymer resin composition for fabricating the second layer of the multilayer film, comprises a polymer resin blend composition including resin (ii), resin (iii), and resin (iv) as follows:

(1) resin (ii) comprises from 40 wt % to 70 wt % of resin (ii) in one embodiment, from 50 wt % to 70 wt % in another embodiment, and from 55 wt % to 65 wt % in still another embodiment, and wherein resin (ii) comprises a metallocene catalyzed LLDPE resin (e.g., Univation HPR 1018HA resin); and

(2) resin (iii) comprises from 5 wt % to 28 wt % of resin (iii) in one embodiment, from 10 wt % to 25 wt % in another embodiment, and from 10 wt % to 20 wt % in still another embodiment; and wherein resin (iii) comprises a metallocene catalyzed LLDPE resin with LCB (e.g., Univation EZP 2703 resin); and wherein the LCB value of resin (iii) is <0.030 branch/1000 carbons; and

(3) resin (iv) comprises from 5 wt % to 28 wt % of resin (iii) in one embodiment, from 10 wt % to 25 wt % in another embodiment, and from 10 wt % to 20 wt % in still another embodiment; and wherein resin (iv) comprises a HDPE resin (e.g., DGDZ 6095 resin).

In one general embodiment, the third film layer of the multilayer film useful in the present invention can be a monolayer or a combination of two or more monolayers (i.e., a multiple number of layers forming the third film layer of the multilayer). In addition, the third film layer of the multilayer film useful in the present invention can be formed from a single polyolefin resin or a blend of two or more polyolefin resins. In one embodiment, the third film layer of the multilayer film is formed, for example, from one or more ethylene-based polymer components. In other embodiments, the third film layer of the multilayer film comprises a polymer resin blend composition that can be used to fabricate an outer layer (e.g., a second outer layer of the multilayer film) the same as the first film layer of the multilayer film or an outer layer different from the first film layer of the multilayer film. In other embodiments, the third layer of the multilayer film can be used as at least one inner layer of the multilayer film. When used as an inner layer, in a preferred embodiment, the third layer of the multilayer film can be a sealable skin layer. The third layer (as the second outer layer or the inner sealant layer of the multilayer film) can be the same or different than the first layer (being the first outer layer of the multilayer film).

In one preferred embodiment, the LLDPE polymer resins used for forming the polymer resin blend composition for forming the third polyolefin film layer 40 of the multilayer film 10 is the same polymer resin blend composition as the first film layer of the multilayer film and includes a polymer resin blend composition of resin (i), resin (ii) and resin (iii). As an illustration of the present invention and not to be limited thereby, in some embodiments, the polymer resin blend composition for fabricating a sealable inner layer as the third film layer of the multilayer film, comprises a polymer resin blend composition including the same resins (i), (ii) and (iii) used for the first film layer of the multilayer film. Resins (i), (ii) and (iii) are described herein above.

Any one or more of the polymer resin blend compositions used to form any one or more of the film layers of the multilayer film of the present invention may optionally include any number of additional components, agents, or additives therein. Thus, one, two or all of the polymer resin blend compositions used to form the layers of the multilayer film may include one or more optional components. For example, one or more other different polyolefin polymer resins, as an additive, may be added to the polymer resin blend compositions of the first, second and/or third film layers. In some embodiments, the optional polymer resin can be, for example, a LDPE polymer resin, another different LLDPE polymer resin, a MDPE polymer resin, or another HDPE polymer resin.

In other embodiments, the polymer resin blend compositions used to form the first layer of the multilayer film, the second layer of the multilayer film, and/or the third layer of the multilayer film may also optionally contain one or more conventional additives including, for example, lubricants, antioxidants, ultraviolet light-promoted degradation inhibitors (“UV stabilizers”), hindered amine stabilizers, acid scavengers, nucleating agents, anti-blocking agents such as silica or talc, processing aids, metal deactivators, dyes, pigments, colorants, anti-fog agents, anti-static agents, plasticizers, viscosity stabilizers, hydrolytic stabilizers, ultraviolet light absorbers, inorganic fillers, fire-retardants, reinforcing agents such as glass fiber and flakes, synthetic (for example, aramid) fiber or pulp, foaming agents, blowing agents, slip additives, release agents, tackifying resins, and combinations of two or more thereof.

In some embodiments, the polymer resin blend composition used to form the first layer of the multilayer film, the second layer of the multilayer film, the third layer of the multilayer film, and combinations thereof may each include up to 5 wt % of any of the above additional optional additives, based on the total weight of the respective layer. For example, the concentration of the optional additive in the first layer, the second layer, the third layer, and combinations thereof may be from 0 wt % to 5 wt % in one embodiment, from 0.1 wt % to 5 wt % in another embodiment, and from 0.5 wt % to 5 wt % in still another embodiment, based on the total weight of the polymer resin blend composition. The incorporation of the optional additive can be carried out by any known process such as, for example, by dry blending, by extruding a mixture of the various constituents, by the conventional masterbatch technique, and the like.

In some embodiments, the multilayer film structure of the present invention may optionally further include one or more additional film layers (in addition to the first layer of the multilayer film, the second layer of the multilayer film and the third layer of the multilayer film). The additional optional film layer can be the same or different than the first layer of the multilayer film, the second layer of the multilayer film and/or the third layer of the multilayer film. For example, in one embodiment, an optional additional fourth film layer may be included in combination with the three layers (the first layer of the multilayer film, the second layer of the multilayer film, and the third layer of the multilayer film) of the multilayer film structure described above. The optional additional fourth film layer and/or any of the optional additional film layers of the present invention, if used, can be a mono-layer film or a multilayer film.

In a multilayer film structure, each layer will serve a particular function or provide some characteristic to the overall multilayer film structure. The additional layer(s) and the polymer resin blend composition of the additional layer(s) is chosen depending on the intended end use application, cost considerations, and the like. For example, additional layers may serve to provide particular structural or functional characteristics, e.g., add bulk to the structure, promote interlayer adhesion, provide barrier properties, thermal properties, optic properties, sealing characteristics, chemical resistance, mechanical properties, abuse resistance, and the like. Accordingly, in some embodiments, optional additional layers useful in the present invention may include, for example, adhesion-promoting interlayers (also referred to as tie layers; barrier films that prevent water or other liquids, oxygen or other gases, light and other elements from permeating through the barrier film; sealant films that are involved in the sealing of the sealant film to itself or the sealing of the sealant film to another layer in a multilayer film; or combinations thereof. In a preferred embodiment, the multilayer film structure of the present invention may, for example, contain tie layers and/or sealant layers.

The optional additional film layer or film layers useful in the present invention may be formed from a polymer resin composition such as a polyethylene resin or a blend of different polyethylene resins. Illustrative of polyethylenes that can be used to form an optional additional layer, can include, but are not limited to, VLDPE resins, LDPE resins, other LLDPE resins, MDPE resins, and other HDPE resins, and a combination thereof. For example, in some embodiments, any of the layers of the multilayer film, such as the core layer, may include a HDPE. The HDPE may be incorporated into the core layer of the multilayer film to increase the stiffness of the core layer. In some applications, it may be important for the multilayer film to possess adequate stiffness, demonstrated by tensile modulus, for example, to prevent deformation and to prevent breakage.

The thickness of each layer of the multilayer film, and of the overall multilayer film, is not particularly limited, and may depend on a number of factors including, for example, the number of layers in the multilayer film, the composition of the layers in the multilayer film, the desired properties of the multilayer film, the desired end-use application of the multilayer film, the manufacturing process of the multilayer film, and other factors such as the die gap employed during film casting or film blowing. Thus, the multilayer films of the present invention can have a variety of thicknesses. For example, in some embodiments, each of the layers of the multilayer film may have a thickness of <1,000 μm in one general embodiment and <500 μm in another embodiment. In other embodiments, each of the layers of the multilayer film may have a thickness of from 1 μm to 1,000 μm in one embodiment, from 5 μm to 500 μm in another embodiment, and from 5 μm to 100 μm in still another embodiment.

The overall thickness of the multilayer film may be at an overall thickness of <1,000 um in one general embodiment and <500 μm in another embodiment. In other embodiments, the multilayer film may have a thickness of from 1 μm to 1,000 μm in one embodiment, from 5 μm to 500 μm in another embodiment, from 10 μm to 500 μm in still another embodiment, from 15 μm to 500 μm in yet another embodiment, from 5 μm to 100 μm in even still another embodiment, and from 10 μm to 100 μm in even yet another embodiment.

In some embodiments, using the monolayer and multilayer polymer films of the present invention having a balance of stiffness and toughness may allow for a reduction of material costs through down-gauging (i.e., using thinner film thicknesses) for various applications such as packaging applications especially when lesser gauges are used (“down-gauging”).

The multilayer films of the present invention exhibit several advantageous properties and benefits over films previously known in the art. For example, the present invention multilayer films show improved performance and mechanical properties including increased toughness, good dart strength, increased stiffness, good processability and bubble stability when preparing blown films comprising the multilayer films of the present invention; increased mechanical and abuse resistance properties to withstand the forces and loads the multilayer films of the present invention may be subjected to; and increased impact and tear resistance.

In some embodiments, when the polymer resin blend composition of at least one layer of the multilayer film contains a metallocene catalyzed LLDPE resin, in one general embodiment the layer formed from the composition containing the metallocene catalyzed LLDPE resin advantageously exhibits at least a 10% improvement in toughness strength in terms of dart strength as compared to a multilayer film made from a resin composition that either (1) does not contain the metallocene catalyzed LLDPE resin of the present invention; (2) contains too much of a metallocene catalyzed LLDPE resin; or (3) contains too little of a metallocene catalyzed LLDPE resin.

In other embodiments, the multilayer film formed from a polymer resin blend composition containing a metallocene catalyzed LLDPE resin of the present invention exhibits at least a 15% improvement in toughness (or dart strength) as compared to a multilayer film made from a resin composition that does not contain the metallocene catalyzed LLDPE resin of the present invention; and in still other embodiments, the multilayer film formed from a polymer resin blend composition containing a metallocene catalyzed LLDPE resin of the present invention exhibits at least a 20% improvement in toughness (or dart strength) as compared to a multilayer film made from a resin composition that does not contain the metallocene catalyzed LLDPE resin of the present invention.

In yet other embodiments, the multilayer film formed from a polymer resin blend composition containing a metallocene catalyzed LLDPE resin of the present invention exhibits from 10% to 50% improvement in toughness (or dart strength) as compared to a multilayer film made from a resin composition that does not contain the metallocene catalyzed LLDPE resin of the present invention; and in even still other embodiments, the multilayer film formed from the polymer resin blend composition containing a metallocene catalyzed LLDPE resin of the present invention exhibits at least from 10% to 30% improvement in toughness (or dart strength) as compared to a multilayer film made from a resin composition that does not contain the metallocene catalyzed LLDPE resin of the present invention.

Other performance properties of the multilayer films including tear resistance (machine direction (MD) and cross direction (CD)), secant modulus, stiffness, and bubble stability is increased or maintained without deleterious effects.

The above improved properties of the multilayer films may allow the production of the films using less materials (“downgauging,” i.e., using thinner film thicknesses) where the effect of down-gauging is not detrimental to certain properties of the film. For example, the physical properties of the multilayer film, such as dart/bag drop, puncture, tear, and creep resistance, may still be maintained and may still meet customer and industry requirements even at reduced thicknesses.

In general, the process used for producing the multilayer film structure of the present invention includes the steps of: (I) producing a polymer resin blend composition for each of the film layers of the multilayer film structure; (II) processing the polymer resin blend compositions to form individual film layers for the multilayer film structure; and (III) contacting together the film layers from step (II) to form a multilayer film structure; wherein at least one of the layers of the multilayer film is prepared from a polymer resin blend composition containing at least one ethylene-based polymer resin; and wherein the at least one ethylene-based polymer resin comprises a metallocene catalyzed LLDPE resin.

As aforementioned, each of the layers making up the multilayer film of the present invention shown in FIG. 1 and FIG. 2 is prepared from a polyolefin resin blend composition; and in a preferred embodiment from an ethylene-based polymer resin blend composition; and in another preferred embodiment from one or more LLDPEs in each layer.

In some embodiments when more than one resin component (i.e., two or more resin components) are used to prepare the polymer resin blend composition for each of the layers, the components of the polymer resin blend composition are first mixed together to form the polymer resin blend composition, and then the polymer resin blend composition is processed into a film structure. For example, the individual resin components of the polymer resin blend composition may be dry blended and subsequently uniformly melt mixed in a mixer; or the resin components may be uniformly mixed together directly in a mixer, such as, for example, a Banbury mixer, a Haake mixer, a Brabender internal mixer, a single screw extruder, or a twin-screw extruder, which can include a compounding extruder and a side-arm extruder.

In some embodiments, for example in forming the 3-layer structure of the multilayer film shown in FIG. 1 includes a first polymer resin blend composition for preparing the first film layer (a) of the multilayer film, another second polymer resin blend composition for preparing the second film layer (b) of the multilayer film, and another third polymer resin blend composition for preparing the third film layer (c) of the multilayer film. For example, in some embodiments, the first polymer resin blend composition for preparing the first film layer (a) of the multilayer film (first film layer 20 shown in FIG. 1), may include at least one Zeigler-Natta (ZN) LLDPE resin (e.g., resin (i)). For example, in some embodiments, the second polymer resin blend composition for preparing the second film layer (b) of the multilayer film (second film layer 30 shown in FIG. 1), may include at least one metallocene LLDPE resin (e.g., resin (ii)). For example, in some embodiments, the third polymer resin blend composition for preparing the third film layer (c) of the multilayer film (third film layer 40 shown in FIG. 1), may include at least one LLDPE with LCB (e.g., resin (iii)).

In a general embodiment, the process used for producing the at least three-layer multilayer film structure of the present invention includes the use of any conventional equipment and processes, known to those skilled in the art, such as for example, techniques utilized to prepare blown films using blow extrusion, extruded films using co-extrusion, and/or cast films using cast extrusion. Alternatively, the multilayer film structures of the present invention can be produced by incorporating the multilayer film in laminated structures.

In some embodiments, for example, multilayer films can be made using a co-extrusion process. In co-extrusion, a plurality of molten polymer streams is fed to an annular die (or flat cast) resulting in a multilayered film on cooling. In a preferred embodiment, the first polymer resin blend composition, the second polymer resin blend composition, and the third polymer resin blend composition used for preparing the first layer of the multilayer film, the second layer of the multilayer film, and the third layer of the multilayer film, respectively, of the present invention, are processed through a blown film process using a typical blowing process and equipment known to those skilled in art of blown film methods and the art of manufacturing multilayer films. For example, in one or more embodiments, the process of manufacturing the multilayer film of the present invention may include forming a blown film bubble by blown film extrusion. In some embodiments, the blown film bubble may be a multilayer blown film bubble. Further in accordance with this embodiment, the multilayer blown film bubble may include at least three layers (in accordance with the first layer of the multilayer film, the second layer of the multilayer film, and the third layer of the multilayer film described above), and the at least three layers may adhere to each other. In other embodiments, multilayer films comprising more than three layers such as five layers, seven layers and the like may be produced using a blown film bubble.

In some embodiments, for example, a blown film bubble may be formed via a blown film extrusion line wherein an extruded film coming from an extruder die may be formed (blown) and pulled up a tower onto a nip. The film may then be wound onto a core. Before the film is wound onto the core, the ends of the film may be cut and folded using folding equipment so that the layers of the film are difficult to separate, which may be important for shipping applications, generally, or heavy-duty shipping sack applications. Other embodiments of the blown film process may include using a blown film extrusion line having: (1) a length to diameter (“L/D”) ratio of, for example, from 30 to 1; (2) a blow-up ratio of, for example, from 1 to 5; (3) a die with internal bubble cooling; (4) a die gap of, for example, from 1 millimeter (mm) to 5 mm; and (5) a film thickness gauge scanner wherein the overall thickness of the multilayer film may be maintained at <1,000 μm as described above. In one general embodiment, the forming of the multilayer blown film bubble step may occur, for example, at a temperature of from 180° C. to 260° C.; and the output speed of the process may be, for example, from 10 kg/hr to 1,000 kg/hr.

In some embodiments, the multilayer film structure of the present invention can be used to produce end use products and articles useful for any number of applications. Exemplary end uses can include, but are not limited to, multilayer films, multilayer film-based products, and articles fabricated from the multilayer films and/or multilayer film-based products such as packaging applications. For example, in a preferred embodiment, the multilayer film structures of the present invention are used to produce heavy-duty bags (or heavy duty shipping sacks utilized in shipping applications); and the heavy-duty bags are prepared by techniques known to those skilled in the art of bag production, such as for example, vertical form fill and seal equipment.

### EXAMPLES

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise stated all parts and percentages are by weight on a total weight basis.

### Resins

### Polymer Resin Compounds

The raw materials/ingredients used in the Examples are the polymer resin components described in Table I. The polymer resin components described in Table I are used for preparing the polymer resin blend compositions/formulations for each of the layers of the multilayer film structures described in Table II. Some of the properties of each of the polymer resin components are also described in Table I.

TABLE I
Polymer Resins

| Polymer Resin Component: | | DFDA-7047 | DFDA-7042 | HPR 1018HA | DGDZ-6095 | LDPE 150E | LDPE 450E | EZP 2703 | EZP [symbol] |
|---|---|---|---|---|---|---|---|---|---|
| Brief Description of Polymer | | ZN LLDPE | ZN LLDPE | MCN LLDPE | HDPE | LDPE | LDPE | EZ-LLDPE | EZ-L [symbol] |
| Resin Component: | | 1 MI | 2 MI | | | 0.3 MI | 2 MI | 0.3 MI | 1MI |
| Supplier of Polymer Resin | | Univation | Univation | Univation | Univation | Dow | Dow | Univation | Univation |
| Component: | | | | | | | | | |
| Polymer | Catalyst: | UCAT J | UCAT J | HP-100 | K-100 | — | — | EZ-100 | EZ-100 |
| Resin | Comonomer: | Butene | Butene | Hexene | Hexene | — | — | Hexene | Hexene |
| Component | Density (g/cc): | 0.918 | 0.918 | 0.918 | 0.948 | 0.921 | 0.923 | 0.928 | 0.922 |
| Properties: | I₂ (g/10 min): | 1 | 2 | 1 | — | 0.25 | 2 | 0.3 | 1 |
| | I₂₁ (g/10 min): | — | — | — | 10 | — | — | — | — |

[symbol]

indicates data missing or illegible when filed

### Resin Formulations

### General Procedure for Preparing Formulations for Film Layers

The resin components described in Table II: DFDA-7047, DFDA-7042, HPR 1018HA, DGDZ-6095, LDPE 150E, LDPE 450E, EZP 2703 and/or EZP 2010, were used in the Examples; and the percentages of each of the resin components used to prepare the polymer resin blend formulations of the Examples are described in Table II. The resin components were mixed together, in the concentrations specified in Table II, using a conventional mixing apparatus and process. The mixing was carried out at a room temperature. The resultant blend/mixture of resin components (i.e., the prepared polymer resin blend formulations) described in Table II were then used to manufacture each of the individual layers of the multilayer film structures described herein below in Table III.

TABLE II
Polymer Resin Blend Formulations

| | Components of Polymer Resin Blend Compositions | | | | | | | |
|---|---|---|---|---|---|---|---|---|
| Example No. of | DFDA- | DFDA- | HPR | DGDZ- | LDPE | LDPE | EZP | EZP |
| Polymer Resin | 7047 | 7042 | 1018HA | 6095 | 150E | 450E | 2703 | 2010 |
| Blend Composition | (%) | (%) | (%) | (%) | (%) | (%) | (%) | (%) |
| Comp. Ex. A | 25 | 0 | 60 | 0 | 15 | 0 | 0 | 0 |
| Comp. Ex. B | 0 | 0 | 55 | 30 | 15 | 0 | 0 | 0 |
| Inv. Ex. 1 | 25 | 0 | 60 | 0 | 0 | 0 | 15 | 0 |
| Inv. Ex. 2 | 0 | 0 | 55 | 30 | 0 | 0 | 15 | 0 |
| Comp. Ex. C | 0 | 75 | 0 | 0 | 0 | 25 | 0 | 0 |
| Comp. Ex. D | 0 | 100 | 0 | 0 | 0 | 0 | 0 | 0 |
| Comp. Ex. E | 0 | 25 | 50 | 0 | 0 | 25 | 0 | 0 |
| Inv. Ex. 3 | 0 | 75 | 0 | 0 | 0 | 10 | 0 | 15 |
| Inv. Ex. 4 | 0 | 25 | 50 | | | 10 | | 15 |
| Inv. Ex. 5 | 0 | 75 | 0 | 0 | 0 | 0 | 0 | 25 |
| Inv. Ex. 6 | 0 | 25 | 50 | 0 | 0 | 0 | 0 | 25 |

### Film Structures

The polymer resin blend formulations described in Table II were used in the Examples to form three-layer multilayer film structures for use as samples for testing. The three-layer multilayer film structures are described in Table III.

TABLE III
3-Layer Multilayer Film Structures

| | | Example No. | | |
|---|---|---|---|---|
| Example No. | Layer of | of Polymer Resin | | |
| of Multilayer | Multilayer | Blend Composition | | Thickness⁾ |
| Film | Film | Used to Make Layer | Ratio | (μm) |
| Comp. Ex. F | Outer layer | Comp. Ex. A | 0.33 | 50 |
| | Middle layer | Comp. Ex. B | 0.33 | 50 |
| | Sealant layer | Comp. Ex. A | 0.33 | 50 |
| Inv. Ex. 7 | Outer layer | Inv. Ex. 1 | 0.33 | 50 |
| | Middle layer | Comp. Ex. B | 0.33 | 50 |
| | Sealant layer | Inv. Ex. 1 | 0.33 | 50 |
| Inv. Ex. 8 | Outer layer | Inv. Ex. 1 | 0.33 | 50 |
| | Middle layer | Inv. Ex. 2 | 0.33 | 50 |
| | Sealant layer | Inv. Ex. 1 | 0.33 | 50 |
| Comp. Ex. G | Outer layer | Comp. Ex. C | 0.33 | 25 |
| | Middle layer | Comp. Ex. D | 0.33 | 25 |
| | Sealant layer | Comp. Ex. E | 0.33 | 25 |
| Inv. Ex. 9 | Outer layer | Inv. Ex. 3 | 0.33 | 25 |
| | Middle layer | Comp. Ex. D | 0.33 | 25 |
| | Sealant layer | Inv. Ex. 4 | 0.33 | 25 |
| Inv. Ex. 10 | Outer layer | Inv. Ex. 5 | 0.33 | 25 |
| | Middle layer | Comp. Ex. D | 0.33 | 25 |
| | Sealant layer | Inv. Ex. 6 | 0.33 | 25 |

### General Procedure for Preparing Multilayer Films

The three-layer multilayer film samples described in Table III were manufactured using an Alpine 7-layer blown film line including 7 extruders as described in Table IV. The film extruder line parameters are described in Table V. The 7-layer blown film line was used to form 7 film layers; and the 7 film layers were used to produce the 3-layer multilayer film samples. Each of the 7 individual films layers was first produced by each of the 7 individual extruders as described in Table IV; and then, the 7 layers from the extruders were brought together to form the 3-layer film structure identified, for example, as an inner layer, a middle layer and an outer layer of the multilayer film structures as described in Table IV. The parameters of the extruders are described in Table V. The extruders were operated at a melt temperature of from 416° F. (213° C.) to 482° F. (250° C.) at an output rate of 324 lbs/hr (147 kg/hr) (3-layer coextrusion).

TABLE IV
Alpine 7-Layer Film Line

| | | Thickness Ratio |
|---|---|---|
| Extruder No. | Layer | (%) |
| Extruder 1 | Inner layer | 16.7 |
| Extruder 2 | | 16.7 |
| Extruder 3 | Middle layer | 11.1 |
| Extruder 4 | | 11.1 |
| Extruder 5 | | 11.1 |
| Extruder 6 | Outer layer | 16.7 |
| Extruder 7 | | 16.7 |

TABLE V
Film Extruder Line Parameters

| Die Size: | 9.84 in | (25 cm) |
|---|---|---|
| Die Gap: | 78.7 mil | (2 mm) |
| Blow Up Ratio (BUR): | 2.5 | |
| Frost Line Height | 35 in | (89 cm) |
| Output Rate: | 324 lbs/hr | (147 kg/hr) |

The resultant three-layer multilayer film samples manufactured with the Alpine blown film line were subjected to testing using the testing methods described herein below.

### Measurements and Test Methods

### Film Characterization

The testing standards listed in Table VI were used to characterize the film structures prepared using the polymer resin formulations described above and used in the Examples.

TABLE VI
Testing Standards for Film Characterization

| Property Tested | Standard |
|---|---|
| Secant Modulus - CD | ASTM D882 |
| Secant Modulus - MD | ASTM D882 |
| Tear: Elmendorf - CD | ASTM D1922 |
| Tear: Elmendorf - MD | ASTM D1922 |
| Dart Drop Impact | ASTM D1709 |

### Density

Resin density was measured by the Archimedes displacement method, ASTM D 792-13, Method B, in isopropanol. Specimens (samples) for this test were measured 40 hr after molding and after conditioning in an isopropanol bath at 23° C. for 8 min to achieve thermal equilibrium prior to measurement. The specimens were compression molded in a press according to ASTM D 4703-16 Annex A, with a 5 min initial heating period at approximately 190° C., and a 15° C./min cooling rate per Annex A Procedure C. The specimens were cooled to 45° C. in the press with continued cooling until the specimens reached room temperature.

### Melt Flow Rate

Melt flow rate measurements were performed according to the procedure described in ASTM D-1238-03 at the following three different conditions: (1) at 190° C. and 2.16 kg, (2) at 190° C. and 5.0 kg, and (3) at 190° C. and 21.6 kg; and the three melt flow rate measurements are designated as I₂, I₅, and I₂₁, respectively. As known to those skilled in the art, melt flow rate is inversely proportional to the molecular weight of a polymer being measured. Thus, the higher the molecular weight of a polymer, the lower the melt flow rate of the polymer, although the relationship is not linear.

### Gel Permeation Chromatography (GPC)

GPC was performed on the specimens to determine the Molecular Weight Distributions (MWD) of the samples and the samples' corresponding moments (Mn, Mw and Mz). The chromatographic system used to measure GPC included a Polymer Char GPC-IR high temperature GPC chromatograph (available from Polymer Char, Valencia, Spain) equipped with a 4-capillary differential viscometer detector and a IR5 multi-fixed wavelength infrared detector (available from Polymer Char). A Precision Detectors 2-angle laser light scattering detector Model 2040 (available from Precision Detectors, currently Agilent Technologies) was added to the chromatographic system. The 15-degree angle of the light scattering detector was used for calculation purposes. Data collection was performed using GPC One software (available from Polymer Char). The system was equipped with an on-line solvent degas device (available from Precision Detectors, currently Agilent Technologies).

Both the carousel compartment and the column compartment of the chromatograph were operated at 150° C. The columns used in the chromatograph were 3 Polymer Laboratories Mixed A 30 cm 20-micron columns and a 20-um pre-column (available from Polymer Laboratories, now Varian). The chromatographic solvent used was 1,2,4 trichlorobenzene (TCB) which contained 200 ppm of butylated hydroxytoluene (BHT). The solvent source was nitrogen sparged. The injection volume used for each of the injection samples was 200 μL and the flow rate of the injected sample was 1.0 mL/min.

For conventional molecular weight measurements, the GPC column set was calibrated with 21 narrow molecular weight distribution polystyrene standards (available from Polymer Laboratories, now Varian) with molecular weights ranging from 580 to 8,400,000 and were arranged in 6 “cocktail” mixtures. The polystyrene standards were prepared at 0.025 g in 50 mL of solvent for molecular weights ≥1,000,000; and 0.05 g in 50 mL of solvent for molecular weights <1,000,000. The polystyrene standards were dissolved at 80° C. with gentle agitation for 30 min. The narrow standards mixtures were run first and in decreasing order from the highest molecular weight component to minimize degradation of the standards. The peak molecular weights of the polystyrene standards were converted to polyethylene molecular weights using the following Equation (II):

$${M}_{polyethylene} = A * ( {M}_{polystyrene} ) B \qquad Equation ( II )$$

where in Equation (II), M is molecular weight, A is a value of 0.4316 for Conventional-Composition GPC results and A in Equation (II) has a value of approximately 0.41 for triple detector backbone MW calculations (referencing an A value that yields 115,000 Mw for a linear reference homopolymer standard 53494-38-4). Value B in Equation (II) is equal to 1.0. A fifth order polynomial was used to fit the respective polyethylene-equivalent calibration points.

### iCCD Method to Reference

An improved comonomer content distribution (iCCD) analysis method described in WO2017040127A1 was used. This iCCD test was performed with Crystallization Elution Fractionation (CEF) instrumentation (available from Polymer Char, Spain) equipped with an IR-5 detector and a two-angle light scattering detector Model 2040. A guard column consisting of a 5 cm or 10 cm (length)×¼in (0.635 cm) (ID) stainless cylinder packed with 20-27 micron glass (available from MoSCi Corporation, USA) was installed just before the IR-5 detector in the detector oven. Ortho-dichlorobenzene (ODCB, 99% anhydrous grade or technical grade) was used as solvent. Silica gel 40 (particle size is 0.2 mm to ˜0.5 mm; available from EMD Chemicals) can be used to dry the ODCB solvent before use of the ODCB solvent. Dried silica was packed into three emptied HT-GPC columns to further purify the ODCB solvent as eluent. The CEF instrument is equipped with an autosampler with nitrogen (N₂) purging capability. ODCB was sparged with dried N2 for 1 hr before use. Sample preparation was done with the autosampler at 4 mg/mL (unless otherwise specified) under shaking at 160° C. for 1 hr. The injection volume of the sample was 300 μL. The temperature profile of iCCD was as follows: crystallization at 3° C./min from 105° C. to 30° C.; thermal equilibrium at 30° C. for 2 min (including Soluble Fraction Elution Time being set as 2 min); elution at 3° C./min from 30° C. to 140° C. The flow rate of the sample during crystallization is 0.0 mL/min. The flow rate of the sample during elution is 0.50 mL/min. The data was collected at one data point/second.

The iCCD column used was a 15 cm (length)×¼in internal diameter (ID) stainless tubing packed with gold coated nickel particles (Bright 7GNM8-NiS; available from Nippon Chemical Industrial Co.). The column packing and conditioning was carried out using a slurry method according to the method described in WO2017040127A1. The final pressure with trichlorobenzene (TCB) slurry packing was 150 bar (10 MPa).

Column temperature calibration was performed by using a mixture of a linear homopolymer polyethylene (a polyethylene having a zero comonomer content, a melt index (I₂) of 1.0 g/cm³, and a polydispersity Mw/Mn of approximately 2.6 as determined by conventional gel permeation chromatography, 1.0 mg/mL) as a “reference material” and Eicosane (2 mg/mL) in ODCB. iCCD temperature calibration consisted of four steps: (1) calculating the delay volume defined as the temperature offset between the measured peak elution temperature of Eicosane minus 30.00° C.; (2) subtracting the temperature offset of the elution temperature from iCCD raw temperature data (it is noted that this temperature offset is a function of experimental conditions, such as elution temperature, elution flow rate, etc.); (3) creating a linear calibration line transforming the elution temperature across a range of 30.00° C. and 140.00° C. so that the linear homopolymer polyethylene reference material had a peak temperature at 101.0° C., and Eicosane had a peak temperature of 30.0° C.; (4) for the soluble fraction measured isothermally at 30° C., the elution temperature below 30.0° C. is extrapolated linearly by using the elution heating rate of 3° C./min according to the method described in U.S. Pat. No. 9,688,795.

### Test Results

TABLE VII
Test Results for Multilayer Films

| Multilayer | Overall | | Elmendorf | Elmendorf | Secant | Secant |
|---|---|---|---|---|---|---|
| Film | Film | | Tear MD | Tear CD | Modulus at | Modulus at |
| Example | Thickness | Dart | g/mil | g/mil | 1% MD psi | 1% CD psi |
| No. | (μm) | (g) | (g/μm) | (g/μm) | (MPa) | (MPa) |
| Comp. Ex. I | 150 | 1,029 | 194(7.6) | 406(16.0) | 41,454(286) | 40,975(283) |
| Inv. Ex. 7 | 150 | 1,134 | 303(11.9) | 387(15.2) | 44,023(304) | 45,265(312) |
| Inv. Ex. 8 | 150 | 1,248 | 305(12.0) | 439(17.3) | 45,983(317) | 47,462(327) |
| Comp. Ex. K | 75 | 276 | 113(4.4) | 353(13.9) | 36,182(249) | 37,619(259) |
| Inv. Ex. 9 | 75 | 315 | 149(5.9) | 377(14.8) | 36,920(255) | 41,194(284) |
| Inv. Ex. 10 | 75 | 330 | 167(6.6) | 336(13.2) | 36,249(250) | 39,676(274) |

### Discussion of Results

As shown in the results described in Table VII; with an addition of EZP resin to replace LDPE in the formulations, both toughness (Dart and Tear MD) and modulus are improved using the proper concentration of EZP resin compared with the formulations without using EZP resin (e.g., Comp. Ex. A formulation as described in Table II).

### OTHER EMBODIMENTS

Embodiment 1: The multilayer film of the present invention includes at least three layers: at least a (a) first polyolefin layer, (b) at least a second polyolefin layer, and (c) at least a third polyolefin layer. Each one of the at least three layers (a)-(c) is either a mono-layer or a multilayer.

Embodiment 2: At least one or more of the at least first polyolefin layer (a), the at least second polyolefin layer (b) and the at least third polyolefin layer (c) of the multilayer film includes a polyolefin polymer resin comprising a metallocene catalyzed LLDPE resin having a LCB value of from 0.001/1000 carbons to <0.1/1000 carbons.

Embodiment 3: The multilayer film of the present invention can be used to fabricate a packaging article for use in packaging applications. For example, the packaging article of the multilayer film can be a heavy-duty packaging bag.

Embodiment 4: The multilayer film of the present invention exhibits an improvement in performance in dart strength when the multilayer film contains a metallocene catalyzed LLDPE resin having a LCB value of from 0.001/1000 carbons to <0.1/1000 carbons. The dart strength of the multilayer film of the present invention can be increased from 5 percent to 10 percent compared to a conventional multilayer film containing no metallocene catalyzed LLDPE. The increase in dart strength of the multilayer film of the present invention can be accomplished while the processability of the multilayer film is maintained.

Embodiment 5: The present invention includes a process for producing the multilayer film of the present invention including the steps of: (I) producing a polymer resin blend composition for each of the film layers of the multilayer film structure; (II) processing the polymer resin blend compositions from step (I) to form an individual film layer for the at least first polyolefin layer (a), the at least second polyolefin layer (b), and the at least third polyolefin layer (c) of the multilayer film structure; and (III) contacting together the individual film layers from step (II) to form a multilayer film structure;

Embodiment 6: A polymer resin blend composition for making the multilayer film of the present invention, wherein the polymer resin blend composition comprises a blend of two or more ethylene-based polymer resins; wherein at least one of the two or more ethylene-based polymer resins is at least one metallocene catalyzed LLDPE resin having a LCB value of from 0.001/1000 carbons to <0.1/1000 carbons; wherein the total concentration of the at least one metallocene catalyzed LLDPE resin having a LCB value of from 0.001/1000 carbons to <0.1/1000 carbons is from 5 wt % to 28 wt % based on the polymer resin blend composition.

Embodiment 7: The polymer resin blend composition of the present invention, wherein the at least one metallocene catalyzed LLDPE resin having a LCB value of from 0.001/1000 carbons to <0.1/1000 carbons is a poly (ethylene-co-1-butene) copolymer resin.

Embodiment 8: The polymer resin blend composition of the present invention, wherein the at least one metallocene catalyzed LLDPE resin having a LCB value of from 0.001/1000 carbons to <0.1/1000 carbons has a density of from 0.915 g/cm³ to 0.925 g/cm³; and wherein the at least one metallocene catalyzed LLDPE resin having a LCB value of from 0.001/1000 carbons to <0.1/1000 carbons has a melt index of from 0.8 g/10 min to 2.5 g/10 min.

Embodiment 9: The polymer resin composition of the present invention, wherein the polymer resin blend composition includes at least one polymer resin selected from the group consisting of: (i) a Zeigler-Natta catalyzed LLDPE resin, (ii) a metallocene catalyzed LLDPE resin, (iii) LLDPE resin with LCB and having a LCB value of from 0.001/1000 carbons to <0.1/1000 carbons, (iv) a high density polyethylene resin, and (v) mixtures thereof.

What is claimed is:

1. A multilayer film comprising at least three layers including:
(a) at least a first polyolefin layer, wherein the at least first polyolefin layer comprises a first outer layer of the multilayer film;
(b) at least a second polyolefin layer, wherein the at least second polyolefin layer comprises a core layer of the multilayer film; and
(c) at least a third polyolefin layer, wherein the at least third polyolefin layer comprises a second outer layer of the multilayer film; wherein the at least third polyolefin layer (c) is the same or different than the at least first polyolefin layer (a);
wherein the at least second polyolefin layer (b) of the multilayer film is disposed in-between the at least first polyolefin layer (a) of the multilayer film and the at least third polyolefin layer (c) of the multilayer film;
wherein the at least first polyolefin layer (a) of the multilayer film, the at least second polyolefin layer (b) of the multilayer film and the at least third polyolefin layer (c) of the multilayer film are contacted together to form a multilayer film structure;
wherein at least one or more of the at least first polyolefin layer (a) of the multilayer film, the at least second polyolefin layer (b) of the multilayer film, and the at least third polyolefin layer (c) of the multilayer film includes a polyolefin polymer resin comprising a metallocene catalyzed linear low density polyethylene resin having a long chain branching value of from 0.001 long chain branches per 1000 carbon atoms (0.001/1000 carbons) to less than 0.1/1000 carbons;
wherein all of the polyolefin polymer resins of the multilayer film are collectively referred to as a polymer resin blend composition; and wherein the total concentration of the metallocene catalyzed linear low density polyethylene resin having a long chain branching value of from 0.001/1000 carbons to less than 0.1/1000 carbons present in the multilayer film is from 5 weight percent to 28 weight percent based on the total weight of the polymer resin blend composition; and
wherein the total concentration of the metallocene catalyzed linear low density polyethylene resin having a long chain branching value of from 0.001/1000 carbons to less than 0.1/1000 carbons is distributed throughout one or more of the at least first polyolefin layer (a) of the multilayer film, the at least second polyolefin layer (b) of the multilayer film and the at least third polyolefin layer (c) of the multilayer film.

2. The film of claim 1, wherein the long chain branching level of the metallocene catalyzed linear low density polyethylene resin having a long chain branching value of from 0.001/1000 carbons to less than 0.1/1000 carbons is controlled at a value of from 0.001/1000 carbons to less than 0.05/1000 carbons; and the total concentration of the metallocene catalyzed linear low density polyethylene resin having a long chain branching value of from 0.001/1000 carbons to less than 0.05/1000 carbons is from 8 weight percent to 18 weight percent based on the total weight of the polymer resin blend composition.

3. The film of claim 1, wherein the metallocene catalyzed linear low density polyethylene resin having a long chain branching value of from 0.001/1000 carbons to less than 0.1/1000 carbons has a density of from 0.915 g/cm³ to 0.930 g/cm³ and a melt index of from 0.2 g/10 min to 2.5 g/10 min.

4. The film of claim 1, wherein the at least first polyolefin layer (a) of the multilayer film is a polyolefin layer product prepared from a polymer resin blend composition comprising a mixture of:
(ai) at least one Ziegler-Natta catalyzed resin comprising a poly (ethylene-co-1-butene) copolymer resin; wherein the concentration of resin (ai) is from 10 weight percent to 50 weight percent based on the weight of the polymer resin blend composition;
(aii) at least one metallocene catalyzed linear low density polyethylene resin comprising a poly (ethylene-co-1-hexene) copolymer resin; wherein the concentration of resin (aii) is from 40 weight percent to 70 weight percent based on the weight of the polymer resin blend composition; and
(aiii) at least one metallocene catalyzed linear low density polyethylene resin comprising a poly (ethylene-co-1-hexene) copolymer resin having a long chain branching value of from 0.001/1000 carbons to less than 0.1/1000 carbons; wherein the concentration of resin (aiii) is from 5 weight percent to 25 weight percent based on the weight of the polymer resin blend composition; wherein the total concentration of components (ai), (aii) and (aiii) is 100 percent by weight.

5. The film of claim 1, wherein the at least second polyolefin layer (b) of the multilayer film is a polyolefin layer product prepared from a polymer resin blend composition comprising a mixture of:
(bi) at least one metallocene catalyzed linear low density polyethylene resin comprising a poly (ethylene-co-1-hexene) copolymer resin; wherein the concentration of resin (bi) is from 40 weight percent to 70 weight percent based on the weight of the polymer resin blend composition;
(bii) at least one high density polyethylene resin; wherein the concentration of resin (bii) is from
20 weight percent to 40 weight percent based on the weight of the polymer resin blend composition; and
(biii) at least one metallocene catalyzed linear low density polyethylene resin comprising a poly (ethylene-co-1-hexene) copolymer resin having a long chain branching value of from 0.001/1000 carbons to less than 0.1/1000 carbons; wherein the concentration of resin (biii) is from 5 weight percent to
25 weight percent based on the weight of the polymer resin blend composition; wherein the total concentration of components (bi), (bii) and (biii) is 100 percent by weight.

6. The film of claim 1, wherein the at least third polyolefin (c) of the multilayer film is a polyolefin layer product prepared from a polymer resin blend composition comprising a mixture of:
(ci) at least one Ziegler-Natta catalyzed resin comprising a poly (ethylene-co-1-butene) copolymer resin; and wherein the concentration of resin (ci) is from 10 weight percent to 50 weight percent based on the weight of the polymer resin blend composition;
(cii) at least one metallocene catalyzed linear low density polyethylene resin comprising a poly (ethylene-co-1-hexene) copolymer resin; wherein the concentration of resin (cii) is from 40 weight percent to 70 weight percent based on the weight of the polymer resin blend composition; and
(ciii) at least one metallocene catalyzed linear low density polyethylene resin comprising a poly (ethylene-co-1-hexene) copolymer resin having a long chain branching value of from 0.001/1000 carbons to less than 0.1/1000 carbons; wherein the concentration of resin (ciii) is from 5 weight percent to
25 weight percent based on the weight of the polymer resin blend composition; wherein the total concentration of components (ci), (cii) and (ciii) is 100 percent by weight.

7. The film of claim 1, wherein each of the at least first polyolefin layer (a) of the multilayer film, the at least second polyolefin layer (b) of the multilayer film, and the at least third polyolefin layer (c) of the multilayer film is prepared from at least one ethylene-based polymer resin; and wherein the at least one ethylene-based polymer resin is from 72 weight percent to 95 weight percent of the polymer resin blend composition and wherein the at least one ethylene-based polymer resin is selected from the group consisting of:
(i) a Zeigler-Natta catalyzed linear low density polyethylene resin;
(ii) a metallocene catalyzed linear low density polyethylene resin;
(iii) a metallocene catalyzed linear low density polyethylene resin having a long chain branching value of from 0.001/1000 carbons to less than 0.1/1000 carbons;
(iv) a high density polyethylene resin; and
(v) mixtures thereof.

8. The film of claim 1, wherein at least one of the at least first polyolefin layer (a) of the multilayer film, the at least second polyolefin layer (b) of the multilayer film, and the at least third polyolefin layer (c) of the multilayer film is prepared from at least one ethylene-based polymer resin; and wherein the at least one ethylene-based polymer resin comprises a metallocene catalyzed linear low density polyethylene resin having a long chain branching value of from 0.001/1000 carbons to less than 0.1/1000 carbons.

9. The film of claim 1, wherein the metallocene catalyzed linear low density polyethylene resin is present in the at least second polyolefin layer (b) comprising the core layer of the multilayer film.

10. The film of claim 1, wherein at least one of the layers of the multilayer film is a layer product prepared from a polymer resin blend composition comprising two or more ethylene-based polymer resins; wherein at least one of the two or more ethylene-based polymer resins of the polymer resin blend composition includes at least one metallocene catalyzed linear low density polyethylene resin having a long chain branching value of from 0.001/1000 carbons to less than 0.1/1000 carbons; and wherein the metallocene catalyzed linear low density polyethylene resin is a poly (ethylene-co-1-hexene) copolymer resin.

11. The film of claim 1, wherein the improvement in performance in dart strength of the multilayer film including a metallocene catalyzed linear low density polyethylene resin having a long chain branching value of from 0.001/1000 carbons to less than 0.1/1000 carbons is increased from 5 percent to 10 percent compared to a conventional multilayer film including no metallocene catalyzed linear low density polyethylene resin having a long chain branching value of from 0.001/1000 carbons to less than 0.1/1000 carbons while maintaining the processability of the multilayer film.

12. The film of claim 1; wherein each of the at least first polyolefin layer (a), the at least second polyolefin layer (b) and the at least third polyolefin layer (c) of the multilayer film is a mono-layer or a multilayer.

13. A packaging article for use in packaging applications comprising the film of claim 1.

14. A process for producing the multilayer film of claim 1 comprising contacting together at least three layers to form the multilayer film; wherein the at least three layers include:
(a) at least a first polyolefin layer, wherein the at least first polyolefin layer comprises a first outer layer of the multilayer film;
(b) at least a second polyolefin layer, wherein the at least second polyolefin layer comprises a core layer of the multilayer film; and
(c) at least a third polyolefin layer, wherein the at least third polyolefin layer comprises a second outer layer of the multilayer film;
wherein the at least second polyolefin layer (b) of the multilayer film is disposed in-between the at least first polyolefin layer (a) of the multilayer film and the at least third polyolefin layer (c) of the multilayer film;
wherein at least one or more of the at least first polyolefin layer (a) of the multilayer film, the at least second polyolefin layer (b) of the multilayer film, and the at least third polyolefin layer (c) of the multilayer film includes a polyolefin polymer resin comprising a metallocene catalyzed linear low density polyethylene resin having a long chain branching value of from 0.001/1000 carbons to less than 0.1/1000 carbons;
wherein all of the polyolefin polymer resins of the multilayer film are collectively referred to as a polymer resin blend composition; and wherein the total concentration of the metallocene catalyzed linear low density polyethylene resin having a long chain branching value of from 0.001/1000 carbons to less than 0.1/1000 carbons present in the multilayer film is from 5 weight percent to 28 weight percent based on the total weight of the polymer resin blend composition; and
wherein the total concentration of the metallocene catalyzed linear low density polyethylene resin having a long chain branching value of from 0.001/1000 carbons to less than 0.1/1000 carbons is distributed throughout one or more of the at least first polyolefin layer (a) of the multilayer film, the at least second polyolefin layer (b) of the multilayer film, and the at least third polyolefin layer (c) of the multilayer film.

15. A polymer resin blend composition for making the multilayer film of claim 1, wherein the polymer resin blend composition comprises a blend of two or more ethylene-based polymer resins;
wherein at least one of the two or more ethylene-based polymer resins is at least one metallocene catalyzed linear low density polyethylene resin having a long chain branching value of from 0.001/1000 carbons to less than 0.1/1000 carbons; and
wherein the total concentration of the at least one metallocene catalyzed linear low density polyethylene resin having a long chain branching value of from 0.001/1000 carbons to less than 0.1/1000 carbons is from 5 weight percent to 28 weight percent based on the weight of the polymer resin blend composition.
